(19) United States
(12) Patent Application Publication
(10) Pub. No.: US 2011/0229384 A1
(43) Pub. Date: Sep. 22, 2011

(54) CONCENTRATE QUALITY IN THE ENRICHMENT OF UG-2 PLATINUM ORE

(75) Inventors: Alexej MICHAILOVSKI, Ludwigshafen (DE); Imme Domke, Mannheim (DE); Frank Bozich, Cranbury, NJ (US); David F. Blackwood, Long Valley, NJ (US)

(73) Assignee: BASF SE, Ludwigshafen (DE)

(21) Appl. No.: 13/047,156

(22) Filed: Mar. 14, 2011

Related U.S. Application Data
(60) Provisional application No. 61/315,028, filed on Mar. 18, 2010.

(51) Int. Cl. C01G 55/00; C01G 7/00

(52) U.S. Cl. 423/22; 423/23; 423/42

(57) ABSTRACT

The present invention relates to a process for separating at least one first substance from a mixture comprising this at least one first substance and at least one second substance, comprising the steps of (A) bringing the mixture comprising at least one first substance and at least one second substance into contact with at least one surface-active substance, (B) if required, addition of at least one dispersing medium to the mixture obtained in step (A) in order to obtain a dispersion, and (C) separation of the adduct of at least one first substance and at least one surface-active substance from the dispersion from step (A) or (B), for example by means of flotation, at least one additive which is either a monomolecular compound comprising amino and carboxyl groups or derivatives thereof or a polymeric compound obtainable by reaction of alkylene oxides and/or aziridines, or mixtures thereof, being added to the mixture comprising at least one first substance and at least one second substance.

The present invention relates to a process for separating at least one first substance from a mixture comprising this at least one first substance and at least one second substance, comprising the steps (A) bringing the mixture comprising at least one first substance and at least one second substance into contact with at least one surface-active substance, if required in the presence of at least one dispersing medium, the surface-active substance binding to the at least one first substance and making the latter hydrophobic or even further increasing the contact angle in the air/water system, (B) if required, addition of at least one dispersing medium to the mixture obtained in step (A) in order to obtain a dispersion, and (C) separation of the adduct of at least one first substance and at least one surface-active substance from the dispersion from step (A) or (B), for example by means of flotation, at least one additive which is either a monomolecular compound comprising amino and carboxyl groups or derivatives thereof or a polymeric compound obtainable by reaction of alkylene oxides and/or aziridines, or mixtures thereof, being added to the mixture comprising at least one first substance and at least one second substance. The additive can be added at any desired time in the process between (A) and (C).

In particular, the present invention relates to a process for enriching metal-containing minerals in the presence of the matrix.

Processes for separating valuable ores from mixtures comprising them are already known from the prior art.

Flotation is the standard method for ore enrichment and in other areas, for example in papermaking, and has been known for about 110 years.

For example, in flotation, sulfidic minerals are milled to a small size and treated with an oil so that they float on the surface of the flotation bath. The desired sulfidic ores can be transported to the surface by using air bubbles.

In modern flotation processes, the ores to be handled are treated with naturally occurring flotation reagents, such as fatty acids and oils, or synthetically prepared reagents, such as surface-active compounds, in order to increase the hydrophobicity of the valuable ores and hence to facilitate the transport to the surface of the flotation bath.

It is an object of the present invention to provide a process by means of which at least one first substance can be efficiently separated from mixtures comprising at least one first substance and at least one second substance. Furthermore, it is an object of the present invention to provide a process which makes it possible to separate off the at least one first substance efficiently and in high yield although further substances which hinder this separation are present in the mixture to be treated. A further object of the present invention is to separate the desired component from a mixture of substances with an improved concentrate quality in order to be able to carry out subsequent working-up steps more efficiently.

These objects are achieved, according to the invention, by a process for separating at least one first substance from a mixture comprising this at least one first substance and at least one second substance, comprising the following steps:
(A) bringing the mixture comprising at least one first substance and at least one second substance into contact with at least one surface-active substance, if required in the presence of at least one dispersing medium, the surface-active substance binding to the at least one first substance and making the latter hydrophobic or increasing the existing hydrophobicity,
(B) if required, addition of at least one dispersing medium to the mixture obtained in step (A) in order to obtain a dispersion,
(C) separation of the adduct of at least one first substance and at least one surface-active substance from the dispersion from step (A) or (B),
   at least one additive selected from the group consisting of compounds of the general formula (I)

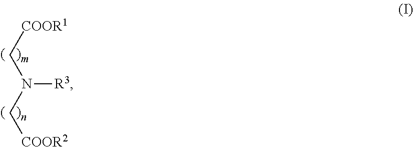

in which m, n, R¹, R² and R³ have the following meanings:
m, n independently of one another, are an integer from 1 to 6,
R¹, R² independently of one another, are H or a negative charge with, independently of one another, associated cations H⁺, alkali metal or alkaline earth metal cations or NR₄⁺ where R, independently of one another, is H or C₁-C₈-alkyl,
R³ independently of one another, is a structural unit selected from units of the general formula (II), (III) and/or (IV)

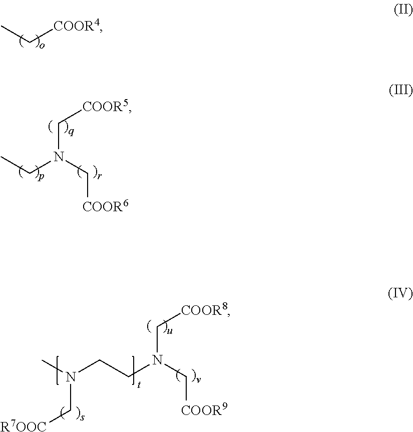

in which o, p, q, r, s, t, u, v, R⁴, R⁵, R⁶, R⁷, R⁸ and R⁹ have the following meanings:
   o, s,
   u, v independently of one another, are an integer from 1 to 6,
   p, q, r, independently of one another, are an integer from 0 to 3,
   t is an integer from 1 to 50,
   R⁴, R⁵, R⁶,
   R⁷, R⁸, R⁹ independently of one another, are H or a negative charge with, independently of one another, associated cations H⁺, alkali metal or alkaline earth metal cations or NR₄⁺ where R,
   R⁴, R⁵, R⁶,
   R⁷, R⁸, R⁹ independently of one another, is H or C₁-C₈-alkyl,
and/or
straight-chain or branched polymeric compounds comprising units of the general formula (V), (VI) and/or (VII)

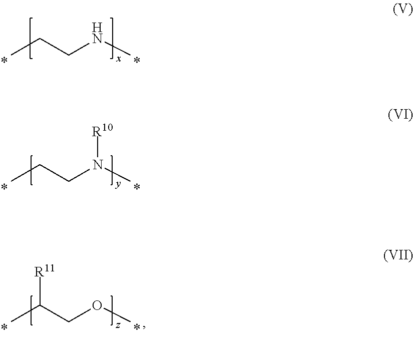

in which x, y, z, R¹⁰ and R¹¹ have the following meanings:
   x, y, z independently of one another, are an integer from 2 to 500,
   R¹⁰ independently of one another, is C₁-C₆-alkyl which is unsubstituted or substituted by hydroxyl, oxo, carboxyl, amino or amido groups,
   and/or
   a straight-chain or branched polymeric group comprising units of the general formula (VIII), (IX) and/or (X)

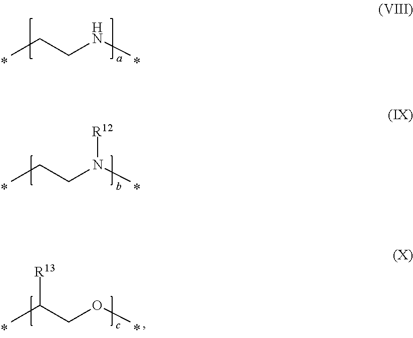

in which a, b, c, R¹² and R¹³ have the following meanings:
   a, b, c independently of one another, are an integer from 1 to 50,
   R¹² independently of one another, is C₁-C₆-alkyl which is unsubstituted or substituted by hydroxyl, oxo, carboxyl, amino or amido groups,
   R¹³ independently of one another, is hydrogen or C₁-C₆-alkyl which is unsubstituted or substituted by hydroxyl, oxo, carboxyl, amino or amido groups,
R¹¹ independently of one another, is hydrogen or C₁-C₆-alkyl which is unsubstituted or substituted by hydroxyl, oxo, carboxyl, amino or amido groups,
   and mixtures thereof being added to the mixture comprising at least one first substance and at least one second substance.

The process according to the invention serves for separating at least one first substance from a mixture comprising this at least one first substance and at least one second substance. In a preferred embodiment, this mixture to be treated according to the invention is an ore, for example an ore comprising the at least one first substance as a valuable component and the at least one second substance as a component which is not desired and which may hinder the separation of the valuable component. In the process according to the invention, particularly preferably untreated ore mixtures which are obtained from commercially exploited ore deposits are accordingly used.

In a preferred embodiment of the process according to the invention, the at least one first substance is selected from the group consisting of Pt, Pd, Au, Rh and mixtures thereof, preferably in each case as a solid solution in sulfidic minerals, such as, for example, chalcopyrite CuFeS₂, bornite Cu₅FeS₄, pentlandite NiₓFe₁₋ₓS (0.3<x<0.7), pyrite FeS₂, marcasite FeS₂ or pyrrotin Fe₁₋ₓS (0<x<0.2) and related minerals, as a compound with other elements, as an alloy with one another or with other metals and/or in native form. In a particularly preferred embodiment, the at least one first substance is selected from the group consisting of Pt, Pd and mixtures thereof, preferably in each case as a compound, as an alloy and/or in native form.

In a preferred embodiment, the present invention relates to the process according to the invention, the at least one first substance being selected from the group consisting of Pt, Pd, Au, Rh and mixtures thereof, in each case as a compound, as an alloy and/or in native form.

Compounds of said metals which may be mentioned by way of example are corresponding sulfides, arsenides, phosphides, binary intermetallic compounds with As, Se or Te or ternary intermetallic compounds with the abovementioned elements and additionally Ag, Hg, Bi, Pb, and other heavy transition metals and corresponding mixing compounds.

Alloys which may be mentioned by way of example are alloys of said metals in elemental form with one another and/or with metals selected from the group consisting of the coinage metals or the iron group (Fe, Co, Ni) and mixtures thereof.

In a preferred embodiment, said preferred first substances, in particular platinum and/or palladium, are present in native form, i.e. in elemental form.

In an embodiment which is particularly preferred according to the invention, the at least one first substance is present in the mixture to be treated in more than one of said forms. For example, compounds of said metals are present alongside alloys of said metals and alongside said metals in native form. In a further preferred embodiment, said first substances are present in association with small amounts of sulfidic copper and/or nickel minerals, for example in amounts of from 0.01 to 0.02% by weight.

The at least one first substance is present in the mixture to be treated in general in an amount of from 0.01 to 100 g/t, preferably from 0.01 to 10 g/t, particularly preferably from 0.2 to 5 g/t, based in each case on the total mixture. In an ore particularly preferably to be treated according to the invention, the at least one first substance, in particular platinum and/or palladium, is present in an exemplary amount of from 3 to 5 g of Pt and/or from 2 to 3 g of Pd, in each case per t of ore.

In a preferred embodiment, the at least one second substance which is present in the mixture to be treated is a compound, an oxide or silicate mineral or a mixture of a plurality of such which occur, for example, in naturally occurring ores, which comprise the first substances preferred according to the invention, in association with said first substances, or forms a significant part of the rock matrix.

In a particularly preferred embodiment of the process according to the invention, the at least one second substance is chromite. Chromite is known per se to the person skilled in the art and has the formula (Mg, Fe^{II})Cr₂O₄, it being possible for the mineral to be substituted by further metals in small amounts too, for example Ca instead of Mg; Fe^{III}, Ni, Co and/or Ti instead of Cr.

The at least one second substance is present in the mixture to be treated according to the invention preferably in an amount of from 20 to 90% by weight, preferably from 40 to 80% by weight, particularly preferably from 60 to 75% by weight, for example about 70% by weight.

In a particularly preferred embodiment, a crude ore from the Bushveld complex known to a person skilled in the art and mineralogically related ores from other localities are used as the mixture to be treated in the process according to the invention. The ore recovered there from the partial formation referred to as UG-2 comprises, for example, from 3 to 5 g of Pt and from 2 to 3 g of Pd, in each case per metric ton of ore. Furthermore, this preferably used ore comprises chromite in an amount of, for example, from 60 to 75% by weight.

In the mixture to be treated according to the invention, at least one third substance may optionally be present in addition to the at least one first substance and the at least one second substance.

For example, the optionally present at least one third substance is a metal compound selected from the group consisting of the metal oxide and metal hydroxide compounds, for example pyroxenes, olivines, silica SiO₂, silicates, alumosilicates, for example feldspars, for example albite Na(Si₃Al)O₈, mica, for example muscovite KAl₂[(OH,F)₂AlSi₃O₁₀], granates (Mg, Ca, Fe^{II})₃(Al, Fe^{III})₂(SiO₄)₃, Al₂O₃, FeO(OH), FeCO₃, Fe₂O₃, Fe₃O₄ and further related minerals and mixtures thereof.

Particularly preferably, minerals from the group consisting of the pyroxenes and olivines are present as third substances.

Pyroxenes have the general formula M¹M²T₂O₆, in which M¹, M² and T represent different positions in the pyroxene structure and may have the following meanings:
M1: Mg²⁺, Fe²⁺, Mn²⁺, Ca²⁺, Na⁺, Li⁺, preferably Mg²⁺, Fe²⁺, Mn²⁺, Ca²⁺,
M²: Mg²⁺, Fe²⁺, Mn²⁺, Al³⁺, Fe³⁺, Ti⁴⁺, Ti³⁺, V³⁺, Sc³⁺, Cr³⁺, Zr⁴⁺, Zn²⁺, preferably Mg²⁺, Fe²⁺, Mn²⁺,
T: Si⁴⁺, Al³⁺, Fe³⁺, preferably Si⁴⁺.

Olivines have the general formula (Mg,Fe)₂[SiO₄], in which optionally a small proportion of magnesium and/or iron can be substituted by nickel.

In a preferred embodiment of the process according to the invention, the mixture comprising at least one first substance and at least one second substance is present in step (A) in the form of particles having a size of from 100 nm to 100 μm, cf. for example U.S. Pat. No. 5,051,199. In a preferred embodiment, this particle size is obtained by milling. Suitable processes and apparatuses are known to a person skilled in the art, for example wet milling in a horizontal or vertical ball mill, rod mill, stirred ball mill or variations thereof, if required supported by vibration.

Thus, in a preferred embodiment of the process according to the invention, the mixture comprising at least one first substance and at least one second substance is milled before or during step (A) to give particles having a size of from 100 nm to 100 μm.

The individual steps of the process according to the invention are described in detail below:

### Step (A):

Step (A) of the process according to the invention comprises bringing the mixture comprising at least one first substance and at least one second substance into contact with at least one surface-active substance, if required in the presence of at least one dispersing medium, the surface-active substance selectively binding to the at least one first substance and making the latter hydrophobic or increasing the existing hydrophobicity.

Suitable and preferred first and second substances are mentioned above.

In the context of the present invention, “surface-active substance” means a substance which is capable of hydrophobizing the surface of the particle to be separated off, i.e. of the first substance, in the presence of other particles which are not to be separated off, i.e. of making said surface hydrophobic relative to the untreated particles. Surface-active substances which can be used according to the invention accumulate on the at least one first substance and result thereby in increased hydrophobicity of the first substance.

In the process according to the invention, a surface-active substance of the general formula (XI)

A-Z (XI)

which binds to the at least one first substance, in which
A is selected from straight-chain or branched C₂-C₃₀-alkyl, C₃-C₃₀-heteroalkyl, optionally substituted C₆-C₃₀-aryl, optionally substituted C₆-C₃₀-heteroalkyl, C₆-C₃₀-aralkyl and
Z is a group with which the compound of the general formula (XI) binds to the at least one hydrophobic substance,
   is preferably used.

In a preferred embodiment, A is a straight-chain or branched C₄-C₂₀-alkyl, particularly preferably C₅-C₁₂-alkyl, very particularly preferably a straight-chain C₄- or C₈-alkyl. Heteroatoms optionally present according to the invention are selected from N, O, P, S and halogens, such as F, Cl, Br and I.

In a further preferred embodiment, A is a straight-chain or branched C₂-C₅-alkyl.

Furthermore, A is preferably a branched C₆-C₁₄-alkyl, the at least one substituent, preferably having 1 to 6 carbon atoms, preferably being present in the 2-position, for example 2-ethylhexyl and/or 2-propylheptyl.

In a further particularly preferred embodiment, Z is selected from the group consisting of anionic groups —(X)ₙ—PO₃²⁻, —(X)ₙ—PO₂S²⁻, —(X)ₙ—POS₂²⁻, —(X)ₙ—PS₂⁻, —(X)ₙ—POS⁻, —(X)ₙ—PO₂⁻, —(X)ₙ—PO₃²⁻—(X)ₙ—CO₂⁻, —(X)ₙ—CS₂⁻, —(X)ₙ—COS⁻, —(X)ₙ—C(S)NHOH, —(X)ₙ—S⁻ where X is selected from the group consisting of O, S, NH, CH₂ and n is 0, 1 or 2, optionally with cations selected from the group consisting of hydrogen, alkali metals or alkaline earth metals, in particular sodium or potassium, NR₄⁺ where R, independently of one another, is hydrogen and/or C₁-C₈-alkyl. According to the invention, said anions and the corresponding cations form neutral compounds of the general formula (XI).

If, in said formulae, n is 2, two identical or different, preferably identical, groups A are present bonded to a group Z.

In a particularly preferred embodiment, compounds are used which are selected from the group consisting of a xanthate A-O—CS₂⁻, a trithiocarbonate A-S—CS₂⁻, a dithiophosphate (A-O)₂PS₂⁻, a dithiophosphinate (A)₂PS₂⁻, a thionocarbamate A-O—C(═S)—N(H)-A′ or a dithiocarbamate (A)₂N—CS₂⁻ or mixtures thereof, A, independently of one another, being a straight-chain or branched, preferably straight-chain, C₂-C₂₀-alkyl, for example ethyl, 1- or 2-propyl, n-butyl or n-octyl, or a branched C₄-C₁₄-alkyl, the branching preferably being present in the 2-position, for example isobutyl, 2-ethylhexyl and/or 2-propylheptyl. Preferably, cations selected from the group consisting of hydrogen, alkali metals or alkaline earth metals, in particular sodium or potassium, NR₄⁺ where R, independently of one another, is hydrogen and/or C₁-C₈-alkyl, are present as counterions in these compounds.

Very particularly preferred compounds of the general formula (XI) are selected from the group consisting of sodium or potassium n- or isopropylxanthate, sodium or potassium butylxanthate, sodium or potassium amyl or isoamylxanthate, sodium or potassium octylxanthate, sodium or potassium di-n-alkyldithiophosphinate, sodium or potassium di-n-alkyldithiophosphate (alkyl=C₂-C₈) and mixtures of these compounds.

The bringing into contact in step (A) of the process according to the invention can be effected by all methods known to a person skilled in the art. Step (A) can be carried out in the absence of a dispersing medium or in dispersion, preferably in suspension, particularly preferably in aqueous suspension.

In an embodiment of the process according to the invention, step (A) is carried out in the absence of a dispersing medium.

For example, the mixture to be treated, after prior comminution in a mill, and the at least one surface-active substance and dispersing medium are combined in the corresponding amounts and mixed. Suitable mixing apparatuses are known to a person skilled in the art, for example stirred containers. The addition of the surface-active substance and of the additive can be effected during the comminution itself or only thereafter.

In a further preferred embodiment, step (A) is carried out in a dispersion, preferably in suspension. Suitable dispersing media are all dispersing media in which the mixture from step (A) is not completely soluble. Suitable dispersing media for the preparation of the slurry or dispersion according to step (A) of the process according to the invention are selected from the group consisting of water, water-soluble organic compounds, for example alcohols having 1 to 4 carbon atoms, and mixtures thereof.

In a particularly preferred embodiment, the dispersing medium in step (A) is water.

Step (A) of the process according to the invention is generally carried out at a temperature of from 1 to 80° C., preferably at from 20 to 40° C., particularly preferably at ambient temperature.

The at least one surface-active substance is generally used in an amount which is sufficient for achieving the desired effect. In a preferred embodiment, the at least one surface-active substance is added in an amount of from 10 to 500 g/t, corresponding to 0.001 to 0.05% by weight, based in each case on the total mixture to be treated. In step (A) or in the following steps of the process according to the invention, optionally further assistants can be added. Corresponding assistants are known per se to the person skilled in the art. The following may be mentioned by way of example:
so-called foaming agents which serve for stabilizing the air bubbles in a flotation process optionally carried out;
so-called regulators, such as pH regulators (e.g. Ca(OH)₂ or H₂SO₄), depressants, such as, for example, carboxymethylcellulose or guar,
the abovementioned additives for preventing chromite enrichment, and
others which serve for optimization and selective separation of ore mixtures.

### Step (B):

The optional step (B) of the process according to the invention comprises the addition of at least one dispersing medium to the mixture obtained in step (A) in order to obtain a dispersion.

In one embodiment, if step (A) is carried out in the absence of a dispersing medium, the mixture obtained in step (A) comprises at least one first substance and at least one second substance which has been modified on the surface with at least one surface-active substance. If step (A) is carried out in the absence of a dispersing medium, step (B) of the process according to the invention is carried out, i.e. at least one suitable dispersing medium is added to the mixture obtained in step (A), in order to obtain a dispersion.

In the embodiment in which step (A) of the process according to the invention is carried out in dispersion, step (B) is not carried out. However, it is possible in this embodiment too to carry out step (B), i.e. to add further dispersing medium, in order to obtain a dispersion having a lower concentration.

Suitable dispersing media are all dispersing media which have already been mentioned with regard to step (A). In a particularly preferred embodiment, the dispersing medium in step (B) is water.

In step (B), therefore, either the mixture present as such from step (A) is converted into a dispersion or the mixture already present in dispersion from step (A) is converted into a dispersion of lower concentration by addition of dispersing medium.

In general, the amount of dispersing medium added in step (A) and/or step (B) can be chosen, according to the invention, so that a dispersion which is readily stirrable and/or transportable is obtained. In a preferred embodiment, the amount of mixture to be treated, based on the total slurry or dispersion, is up to 70% by weight, particularly preferably from 5 to 40% by weight.

In a preferred embodiment of the process according to the invention, step (B) is not carried out, but step (A) is carried out in aqueous dispersion so that a mixture which has the correct concentration for use in step (C) of the process according to the invention is obtained directly in aqueous dispersion in step (A).

The addition of dispersing medium in step (B) of the process according to the invention can be effected, according to the invention, by all methods known to the person skilled in the art.

### Step (C):

Step (C) of the process according to the invention comprises the separation of the adduct of at least one further substance and at least one surface-active substance from the dispersion from step (A) or (B).

Step (C) of the process according to the invention can be effected in general by all methods known to the person skilled in the art, for example flotation or other methods in which the different hydrophobicity of the components of a mixture is used for the separation.

Flotation methods for separating mixtures comprising at least two different solids, for example ores comprising valuable ores and matrix, are known per se to the person skilled in the art.

In the separation of mixtures of substances by flotation, air is introduced into the flotation bath comprising the mixture to be separated and a dispersing medium, for example by means of a high-speed stirrer or lances, and is finally distributed. Any surfactants and foam stabilizers present in the flotation bath stabilize the air bubbles. According to the invention, the at least one hydrophobized first substance is poorly wettable with water and therefore adheres to the air bubbles. These particles float with the air bubbles and can be skimmed off with the foam. The at least one second substance, which adheres less strongly to the air bubbles owing to its hydrophilicity, remains in dispersion and is pumped off at the end of the flotation process.

Fine milling is necessary for this process in order sufficiently to break up the ore present and to enable the finely distributed air bubbles to transport small mineral particles to the surface of the dispersion and to keep them in the foam blanket.

According to the invention, a one-stage flotation can be carried out. It is also possible, according to the invention, to carry out a multistage flotation, i.e. to treat the mixture to be separated in two, three, four or more stages by flotation.

The process according to the invention is distinguished in that at least one additive selected from the group consisting of compounds of the general formula (I)

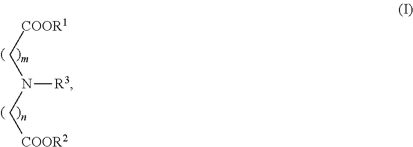

in which m, n, R¹, R² and R³ have the following meanings:
m, n independently of one another, are an integer from 1 to 6,
R¹, R² independently of one another, are H or a negative charge with, independently of one another, associated cations H⁺, alkali metal or alkaline earth metal cations or NR₄⁺ where R, independently of one another, is H or C₁-C₈-alkyl,
R³ independently of one another, is a structural unit selected from units of the general formula (II), (III) and/or (IV)

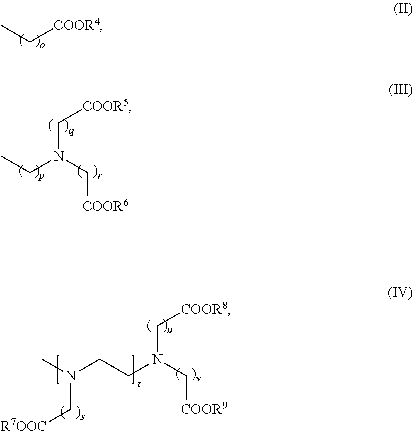

in which o, p, q, r, s, t, u, v, R⁴, R⁵, R⁶, R⁷, R⁸ and R⁹ have the following meanings:
   o, s,
   u, v independently of one another, are an integer from 1 to 6,
   p, q, r, independently of one another, are an integer from 0 to 3,
   t is an integer from 1 to 50,
   R⁴, R⁵, R⁶,
   R⁷, R⁸, R⁹ independently of one another, are H or a negative charge with, independently of one another, associated cations H⁺, alkali metal or alkaline earth metal cations or NR₄⁺ where R, independently of one another, is H or C₁-C₈-alkyl, and/or
      straight-chain or branched polymeric compounds comprising units of the general formula (V), (VI) and/or (VII)

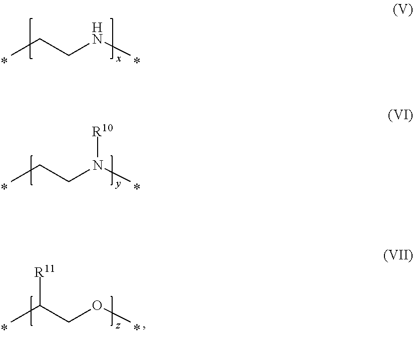

in which x, y, z, R¹⁰ and R¹¹ have the following meanings:
x, y, z independently of one another, are an integer from 2 to 500,
R¹⁰ independently of one another, is C₁-C₆-alkyl which is unsubstituted or substituted by hydroxyl, oxo, carboxyl, amino or amido groups,
and/or
a straight-chain or branched polymeric group comprising units of the general formula (VIII), (IX) and/or (X)

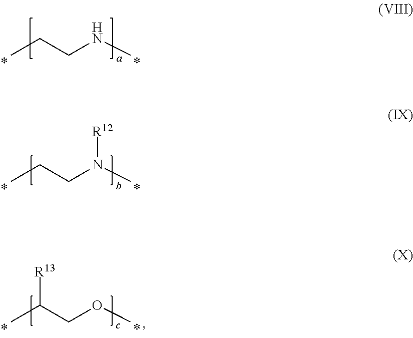

in which a, b, c, R¹² and R¹³ have the following meanings:
   a, b, c independently of one another, are an integer from 1 to 50,
   R¹² independently of one another, is C₁-C₆-alkyl which is unsubstituted or substituted by hydroxyl, oxo, carboxyl, amino or amido groups,
R¹³ independently of one another, is hydrogen or C₁-C₆-alkyl which is unsubstituted or substituted by hydroxyl, oxo, carboxyl, amino or amido groups,
R¹¹ independently of one another, is hydrogen or C₁-C₆-alkyl which is unsubstituted or substituted by hydroxyl, oxo, carboxyl, amino or amido groups, and mixtures thereof is added to the mixture comprising at least one first substance and at least one second substance.

Said additives can be added at any point in the process according to the invention, for example before and/or in stage (A), (B) and/or (C). It is possible according to the invention to add the total amount of said additives in one step. It is also possible in a further embodiment to add parts of the total amount of said additives distributed over one stage or in different stages.

Those embodiments of the abovementioned compounds of the general formulae (I) to (IV) or of the abovementioned polymeric compounds which are preferred according to the invention are mentioned below.

In the compound of the general formula (I)

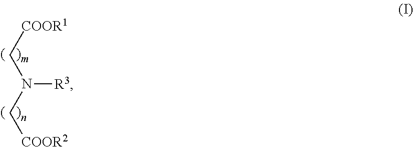

m and n, independently of one another, are an integer from 1 to 6, i.e. 1, 2, 3, 4, 5 and/or 6. In a preferred embodiment, m is 1, 2 or 3, particularly preferably 1. In a further preferred embodiment, n is 1, 2 or 3, particularly preferably 1. In a further preferred embodiment, m and n are each 1.

R¹ and R², independently of one another, are in general H or a negative charge, with the abovementioned associated cations.

Examples of alkali metal cations which are suitable according to the invention are Li⁺, Na⁺, K⁺, Rb⁺ and Cs⁺.

Examples of alkaline earth metal cations which are suitable according to the invention are Be²⁺, Mg²⁺, Ca²⁺, Sr²⁺ and Ba²⁺.

In a very particularly preferred embodiment, R¹ and R² are each hydrogen.

R³, independently of one another, is in general a structural unit selected from units of the general formula (II), (III) and/or (IV)

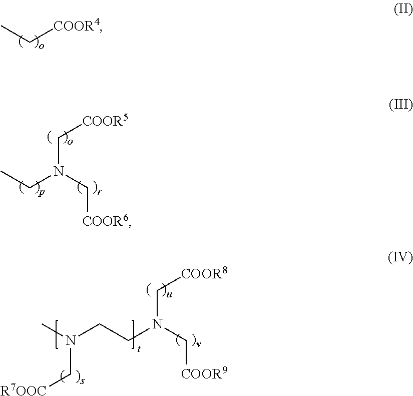

having the abovementioned meanings for o, p, q, r, s, t, u, v, R⁴, R⁵, R⁶, R⁷, R⁸ and R⁹.

In a first embodiment according to the invention, R³ is a structural unit of the general formula (II)

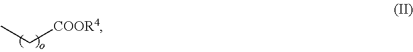

in which o is an integer from 1 to 6, i.e. 1, 2, 3, 4, 5 or 6, preferably 1, and R⁴, independently of one another, is in general H or a negative charge with the abovementioned associated cations.

In a very particularly preferred embodiment, R⁴ is hydrogen.

In this first embodiment, the compound of the formula (Ia):

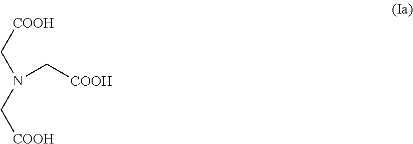

is therefore particularly preferably used as an additive in the process according to the invention.

In a further embodiment according to the invention, R³ is a structural unit of the general formula (III)

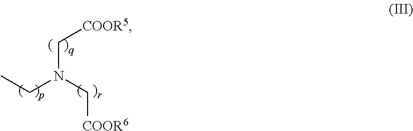

in which p, q and r, independently of one another, are an integer from 0 to 3, i.e. 0, 1, 2 or 3, preferably in each case 1, and R⁵ and R⁶, independently of one another, are in general H or a negative charge with, independently of one another, associated cations H⁺, alkali metal or alkaline earth metal cations or NR₄⁺ where R, independently of one another, is H or C₁-C₈-alkyl.

In a very particularly preferred embodiment, R⁵ and R⁶ are each hydrogen.

In this second embodiment, particularly preferably ethylenediaminetetraacetic acid (EDTA) of the formula (Ib) or its salts:

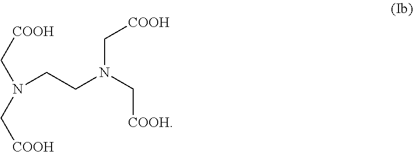

are therefore used as an additive in the process according to the invention.

In a further embodiment according to the invention, R³ is a structural unit of the general formula (IV)

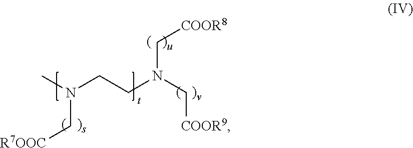

in which s, u and v, independently of one another, are an integer from 1 to 6, i.e. 1, 2, 3, 4, 5 or 6, preferably in each case 1, t is an integer from 1 to 50, preferably from 1 to 5. R⁷, R⁸ and R⁹, independently of one another, are in general H or a negative charge with the abovementioned associated cations.

In a very particularly preferred embodiment, R⁷, R⁸ and R⁹ are each hydrogen.

In this third embodiment, particularly preferably the compound of the formula (Ic):

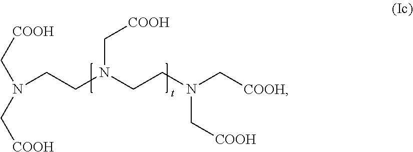

in which t is an integer from 1 to 50, is therefore used as an additive in the process according to the invention.

In a further embodiment, straight-chain or branched polymeric compounds comprising units of the general formula (V), (VI) and/or (VII)

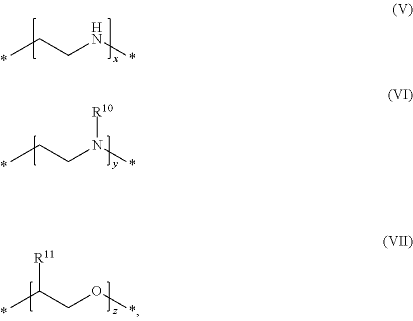

having the abovementioned meanings for x, y, z, R¹⁰ and R¹¹, are used as an additive in the process according to the invention.

The polymers used are composed of one or more of said building blocks (V), (VI) and/or (VII). If the polymer used is composed only of one type of building block, according to the invention a homopolymer is used. If the polymer used is composed of two or more different building blocks, according to the invention a copolymer is used.

According to the invention, x, y and z, independently of one another, are an integer from 1 to 500, preferably from 5 to 100. The variables x, y and z therefore describe the number of corresponding building blocks (V), (VI) and/or (VII) which are linked to one another in blocks.

The building block of the formula (V) which is optionally present according to the invention is derived from aziridine, which was reacted in a ring-opening polymerization, or from a corresponding amine, for example a 2-haloamine which has been reacted in a polycondensation reaction.

In the building block of the general formula (VI) which is optionally present according to the invention, R¹⁰ may have the following meanings:

In a first embodiment, in general R¹⁰, independently of one another, may be H or a C₁-C₆-alkyl which is unsubstituted or substituted by hydroxyl, oxo, carboxyl, amino or amido groups.

In a further embodiment according to the invention, R¹⁰ is a straight-chain or branched polymeric group comprising units of the general formula (VIII), (IX) and/or (X)

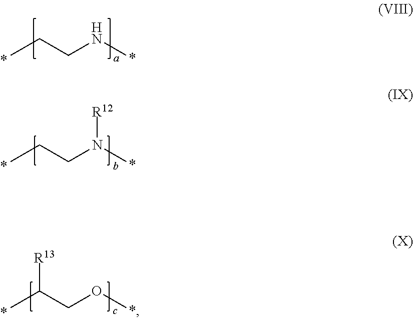

in which a, b, c, R¹² and R¹³ have the following meanings:
a, b, c independently of one another, are an integer from 1 to 500,
R¹² is H or a C₁-C₆-alkyl which is unsubstituted or substituted by hydroxyl, oxo, carboxyl, amino or amido groups,
R¹³ independently of one another, is hydrogen or substituted or unsubstituted C₁-C₆-alkyl, for example methyl, ethyl, propyl, butyl, hydroxymethyl (—CH₂OH), 1- or 2-hydroxyethyl (—CH(OH)—CH₃ or —CH₂—CH₂—OH) and the like.

In this embodiment according to the invention, branched polymers comprising building blocks of the general formula (VI) with the corresponding meanings for R¹⁰ are used as additives.

The polymeric compounds which can be used in the process according to the invention are obtainable by processes known to the person skilled in the art, for example ring-opening polymerization of alkylene oxides, for example ethylene oxide, propylene oxide, butylene oxide, etc., and/or aziridines, or polycondensation of corresponding monomeric precursor compounds, for example 2-haloamines or 2-haloalcohols. Polymeric compounds which can be used according to the invention have a molar mass of in general at least 500 g/mol, preferably 2000-8000 g/mol.

In the building block of the general formula (VII), R¹¹, independently of one another, is in general hydrogen, substituted or unsubstituted C₁-C₆-alkyl, for example methyl, ethyl, propyl, butyl, or a C₁-C₆-alkyl substituted by hydroxyl, oxo, carboxyl, amino or amido groups.

If R¹¹ is hydrogen, the corresponding building blocks of the formula (VII) are derived from ethylene oxide. If R¹¹ is methyl, the corresponding building blocks of the formula (VII) are derived from propylene oxide. If R¹¹ is ethyl, the corresponding building blocks of the formula (VII) are derived from butene oxide, etc.

The compounds or polymeric compounds used according to the invention as an additive are firstly commercially available and/or can be prepared by processes known to the person skilled in the art.

According to the invention, individual compounds or polymers from among the abovementioned compounds or polymers, or mixtures of two or more of said compounds or polymers can be used as an additive.

Said additives are used in the process according to the invention in an amount which can easily be determined by the person skilled in the art, for example in an amount of from 10 to 500 g of additive per t of mixture to be treated, preferably per t of ore to be separated. The amount to be used is dependent on the mixture to be treated, i.e. on the separation problem to be solved, but can easily be determined by the person skilled in the art.

It was found that the addition, according to the invention, of the above-mentioned additives during the process according to the invention has the result that metal cations which interfere with the process, for example copper, nickel and/or iron cations, which are present in the mixture to be separated since they are liberated, for example, during the milling of the crude ore, can be complexed by said additives and thus removed from the process.

In the processes of the prior art, said interfering metal cations are present in the mixture to be treated. These metal cations are at least partly adsorbed by the surface of further components which are present in the mixture and are actually to be separated off, for example of the chromite. Via the metal cations adsorbed in this manner, the surface-active compounds used according to the invention bind to the modified surface of the chromite. Owing to the surface-active substances bound thereon, the surface of the chromite therefore has a hydrophobicity similar to that of the at least one first substance treated with surface-active substance. This similarity in the hydrophobicity of desired first substance and undesired second substance complicates a separation of the first and the second substance, so that the resulting concentrate quality of the first substance obtained is not sufficient.

On subsequent smelting of the first substance obtained, the second substances which may be present, in particular chromite present, present problems. For example, from a proportion of 1.5% by weight of chromite, a corresponding smelting is disturbed since the melting point of the mixture and the viscosity of the melt increase. The melting point must be increased, which is associated with additional costs for energy and apparatuses.

The process according to the invention therefore makes it possible, by addition of said additives, to reduce the proportion of the at least one second substance in the concentrate so that the desired first substance which is obtained after step (C) is present in a higher purity, which once again has an advantageous effect on further process steps.

The present invention also relates to the use of compounds of the general formula (I)

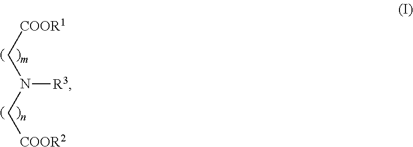

in which m, n, R¹, R² and R³ have the following meanings:
m, n independently of one another, are an integer from 1 to 6,
R¹, R² independently of one another, are H or a negative charge with, independently of one another, associated cations H⁺, alkali metal or alkaline earth metal cations or NR₄⁺ where R, independently of one another, is H or C₁-C₈-alkyl,
R³ independently of one another, is a structural unit selected from units of the general formula (II), (III) and/or (IV)

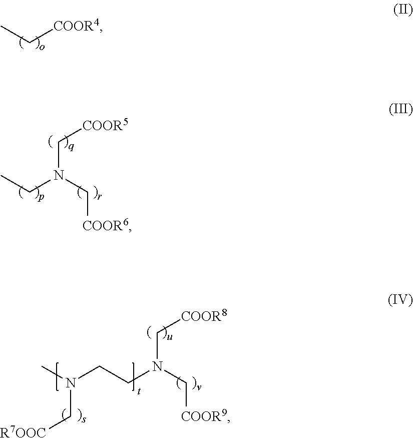

in which o, p, q, r, s, t, u, v, R⁴, R⁵, R⁶, R⁷, R⁸ and R⁹ have the following meanings:
   o, s,
   u, v independently of one another, are an integer from 1 to 6,
   p, q, r, independently of one another, are an integer from 0 to 3,
   t is an integer from 1 to 50,
      R⁴, R⁵, R⁶,
      R⁷, R⁸, R⁹ independently of one another, are H or a negative charge with, independently of one another, associated cations H⁺, alkali metal or alkaline earth metal cations or NR₄⁺ where R, independently of one another, is H or C₁-C₈-alkyl,
         and/or
         straight-chain or branched polymeric compounds comprising units of the general formula (V), (VI) and/or (VII)

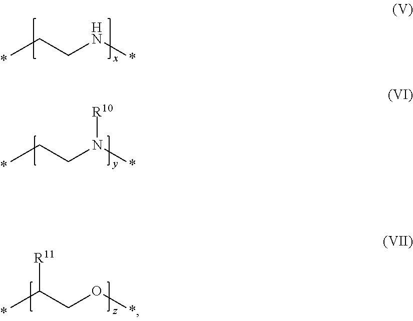

in which x, y, z, R¹⁰ and R¹¹ have the following meanings:
   x, y, z independently of one another, are an integer from 2 to 500,
   R¹⁰ independently of one another, is C₁-C₆-alkyl which is unsubstituted or substituted by hydroxyl, oxo, carboxyl, amino or amido groups,
   and/or
   a straight-chain or branched polymeric group comprising units of the general formula (VIII), (IX) and/or (X)

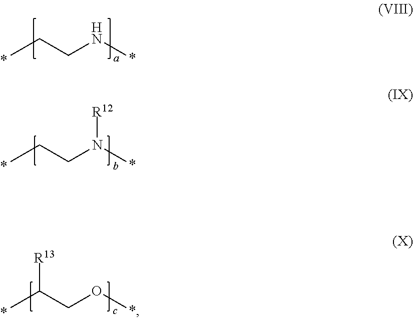

in which a, b, c, R¹² and R¹³ have the following meanings:
   a, b, c, independently of one another, are an integer from 1 to 50,
   R¹² independently of one another, is C₁-C₆-alkyl which is unsubstituted or substituted by hydroxyl, oxo, carboxyl, amino or amido groups,
   R¹³ independently of one another, is hydrogen or C₁-C₆-alkyl which is unsubstituted or substituted by hydroxyl, oxo, carboxyl, amino or amido groups,
R¹¹ independently of one another, is hydrogen or C₁-C₆-alkyl which is unsubstituted or substituted by hydroxyl, oxo, carboxyl, amino or amido groups,
   and mixtures thereof in the separation of at least one first substance from a mixture comprising this at least one first substance and at least one second substance.

Details and preferred embodiments of this subject according to the invention are described in detail above with regard to the process according to the invention.

We claim:

1. A process for separating at least one first substance from a mixture comprising this at least one first substance and at least one second substance, comprising the following steps:
(A) bring the mixture comprising at least one first substance and at least one second substance into contact with at least one surface-active substance, if required in the presence of at least one dispersing medium, the surface-active substance binding to the at least one first substance and making the latter hydrophobic or increasing the existing hydrophobicity,
(B) if required, addition of at least one dispersing medium to the mixture obtained in step (A) in order to obtain a dispersion,
(C) separation of the adduct of at least one first substance and at least one surface-active substance from the dispersion from step (A) or (B),
wherein at least one additive selected from the group consisting of compounds of the general formula (I) 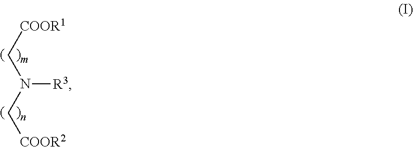
in which m, n, R¹, R² and R³ have the following meanings:
m, n independently of one another, are an integer from 1 to 6,
R¹, R² independently of one another, are H or a negative charge with, independently of one another, associated cations H⁺, alkali metal or alkaline earth metal cations or NR₄⁺ where R, independently of one another, is H or C₁-C₈-alkyl,
R³ independently of one another, is a structural unit selected from units of the general formula (II), (III) and/or (IV) 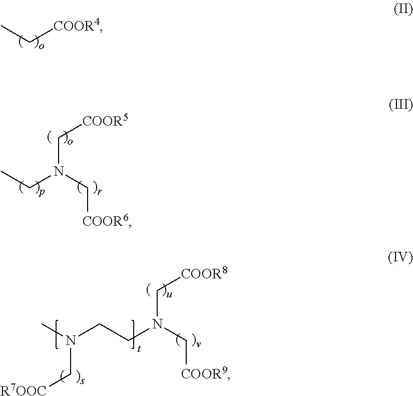
in which o, p, q, r, s, t, u, v, R⁴, R⁵, R⁶, R⁷, R⁸ and R⁹ have the following meanings:
o, s,
u, v independently of one another, are an integer from 1 to 6,
p, q, r, independently of one another, are an integer from 0 to 3,
t is an integer from 1 to 50,
R⁴, R⁵, R⁶,
R⁷, R⁸, R⁹ independently of one another, are H or a negative charge with, independently of one another, associated cations H⁺, alkali metal or alkaline earth metal cations or NR₄⁺ where R, independently of one another, is H or C₁-C₈-alkyl,
and/or
straight-chain or branched polymeric compounds comprising units of the general formula (V), (VI) and/or (VII) 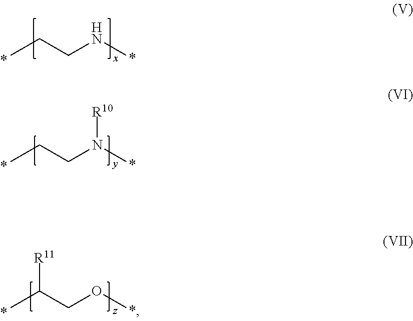
in which x, y, z, R¹⁰ and R¹¹ have the following meanings:
x, y, z independently of one another, are an integer from 2 to 500,
R¹⁰ independently of one another, is C₁-C₆-alkyl which is unsubstituted or substituted by hydroxyl, oxo, carboxyl, amino or amido groups,
and/or
a straight-chain or branched polymeric group comprising units of the general formula (VIII), (IX) and/or (X) 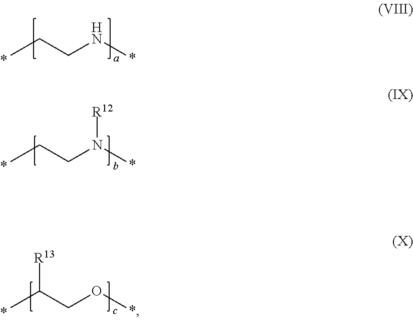
in which a, b, c, R¹² and R¹³ have the following meanings:
a, b, c independently of one another, are an integer from 1 to 50,
R¹² independently of one another, is C₁-C₆-alkyl which is unsubstituted or substituted by hydroxyl, oxo, carboxyl, amino or amido groups,
R¹³ independently of one another, is hydrogen or C₁-C₆-alkyl which is unsubstituted or substituted by hydroxyl, oxo, carboxyl, amino or amido groups,
R¹¹ independently of one another, is hydrogen or C₁-C₆-alkyl which is unsubstituted or substituted by hydroxyl, oxo, carboxyl, amino or amido groups,
and mixtures thereof is added to the mixture comprising at least one first substance and at least one second substance.

2. The process according to claim 1, wherein the at least one first substance is selected from the group consisting of Pt, Pd, Au, Rh and mixtures thereof, in each case as a compound, as an alloy and/or in native form.

3. The process according to claim 1, wherein the at least one second substance is chromite (Mg, Fe)Cr₂O₄.

4. The process according to claim 1, wherein the surface-active substance is a substance of the general formula (XI)
A-Z (XI)
in which
A is selected from straight-chain or branched C₂-C₃₀-alkyl, C₃-C₃₀-heteroalkyl, optionally substituted C₆-C₃₀-aryl, optionally substituted C₆-C₃₀-heteroalkyl, C₆-C₃₀-aralkyl and
Z is a group with which the compound of the general formula (XI) binds to the at least one hydrophobic substance.

5. The process according to claim 4, wherein Z is selected from the group consisting of anionic groups —(X)ₙ—PO₃²⁻, —(X)ₙ—PO₂S²⁻, —(X)ₙ—POS₂²⁻, —(X)ₙ—PS₃²⁻, —(X)ₙ—PS₂⁻, —(X)ₙ—POS⁻, —(X)ₙ—PO₂⁻, —(X)ₙ—PO₃²⁻—(X)ₙCO₂⁻, —(X)ₙ—CS₂⁻, —(X)ₙ—COS⁻, —(X)ₙ—C(S)NHOH, —(X)ₙ—S⁻ where X is selected from the group consisting of O, S, NH, CH₂ and n is 0, 1 or 2, optionally with cations selected from the group consisting of hydrogen, alkali or alkaline earth metals.

6. The process according to claim 1, wherein the dispersing medium is water.

7. The process according to claim 1, wherein the mixture comprising at least one first substance and at least one second substance is milled before or during step (A) to give particles having a size of from 100 nm to 100 μm.

8. The method of using compounds of the general formula (I) 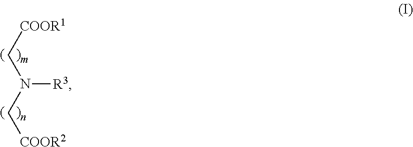
in which m, n, R¹, R² and R³ have the following meanings:
m, n independently of one another, are an integer from 1 to 6,
R¹, R² independently of one another, are H or a negative charge with, independently of one another, associated cations H⁺, alkali metal or alkaline earth metal cations or NR₄⁺ where R, independently of one another, is H or C₁-C₈-alkyl,
R³ independently of one another, is a structural unit selected from units of the general formula (II), (III) and/or (IV) 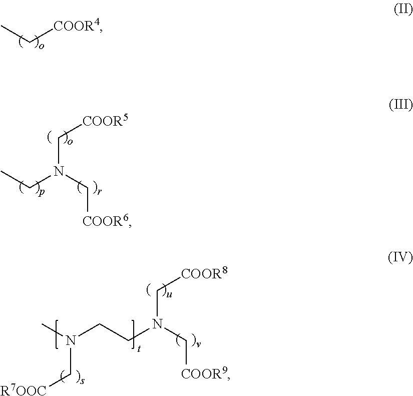
in which o, p, q, r, s, t, u, v, R⁴, R⁵, R⁶, R⁷, R⁸ and R⁹ have the following meanings:
o, s,
u, v independently of one another, are an integer from 1 to 6,
p, q, r, independently of one another, are an integer from 0 to 3,
t is an integer from 1 to 50,
R⁴, R⁵, R⁶,
R⁷, R⁶, R⁹ independently of one another, are H or a negative charge with, independently of one another, associated cations H⁺, alkali metal or alkaline earth metal cations or NR₄⁺ where R, independently of one another, is H or C₁-C₈-alkyl,
and/or
straight-chain or branched polymeric compounds comprising units of the general formula (V), (VI) and/or (VII) 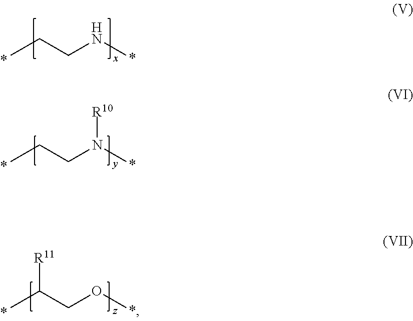
in which x, y, z, R¹⁰ and R¹¹ have the following meanings:
x, y, z independently of one another, are an integer from 2 to 500,
R¹⁰ independently of one another, is C₁-C₆-alkyl which is unsubstituted or substituted by hydroxyl, oxo, carboxyl, amino or amido groups,
and/or
a straight-chain or branched polymeric group comprising units of the general formula (VIII), (IX) and/or (X) 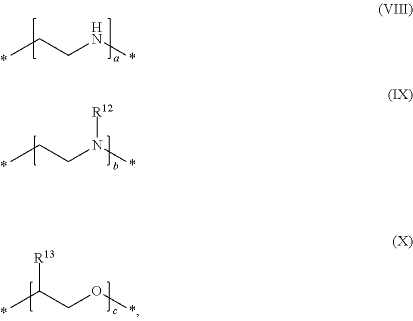
in which a, b, c, R¹² and R¹³ have the following meanings:
a, b, c independently of one another, are an integer from 1 to 50,
R¹² independently of one another, is C₁-C₆-alkyl which is unsubstituted or substituted by hydroxyl, oxo, carboxyl, amino or amido groups,
R¹³ independently of one another, is hydrogen or C₁-C₆-alkyl which is unsubstituted or substituted by hydroxyl, oxo, carboxyl, amino or amido groups,
R¹¹ independently of one another, is hydrogen or C₁-C₆-alkyl which is unsubstituted or substituted by hydroxyl, oxo, carboxyl, amino or amido groups,
and mixtures thereof in the separation of at least one first substance from a mixture comprising this at least one first substance and at least one second substance.
